(19) United States
(12) Patent Application Publication
(10) Pub. No.: US 2006/0184705 A1
(43) Pub. Date: Aug. 17, 2006

(54) Communication system, digital camera and docking apparatus

(76) Inventor: Yukio Nakajima, Kanagawa (JP)

Correspondence Address: Pamela R. Crocker;Patent Legal Staff, Eastman Kodak Company, 343 State Street, Rochester, NY, 14650-2201, US

(21) Appl. No.: 11/258,696

(22) Filed: Oct. 26, 2005

(30) Foreign Application Priority Data
Feb. 17, 2005 (JP) 2005-040682

(51) Int. Cl. G06F 13/00

(52) U.S. Cl. 710/303

(57) ABSTRACT

Wireless communications between a digital camera and a printer dock are established in a simple manner. A processor (10f) of a digital camera (10) detects a printer dock (12) within communication range via a communications circuit (10e) and its ID is acquired. The processor (10f) uses the acquired ID to transmit a sequential power transmit request to the printer dock (12). In response to this request, the printer dock (12) wirelessly transmits power from a communications circuit (12b) and a transmitting coil (12c). When power is received by a receiving coil (10a), it specifies that printer dock (12) is the communication party, and photographed data is wirelessly transmitted using an ID of the specified printer dock (12).

### FIELD OF THE INVENTION

The present invention relates to a communication system and more particularly to data communications between a mobile terminal apparatus, such as a digital camera, and a base station apparatus, such as a docking apparatus (for example, printer dock).

### BACKGROUND OF THE INVENTION

A secondary battery, such as a Ni-MH or Li-ion battery, is built into digital cameras and is charged by power that is supplied from an external power supply. Systems have been proposed where a digital camera is placed on the printer dock to easily enable the printing of images captured with the digital camera or to store the photographed images into a high capacity storage apparatus in the docking apparatus, where in these systems the image data stored in the memory of the digital camera is transmitted to the docking apparatus from the digital camera via connection terminals. However, the image data can also be transmitted wirelessly due to advances in wireless communications technology, such as WiFi or Bluetooth (registered trademark). To transmit the image data wirelessly, it is necessary for the digital camera to unmistakably specify the docking apparatus to which transmissions are to be made.

A technique for performing wireless communications between a cellular phone and a personal computer is proposed in Japanese Patent Laid-Open Publication No. 2003-32175. A contact-less IC card that communicates wirelessly with a reader/writer at a personal computer is provided in the cellular phone. When an electromagnetic wave that is transmitted from the reader/writer is received by the contact-less IC card as a user holds the cellular phone in proximity to the personal computer, the cellular phone informs the personal computer of the card ID that has been set in the contact-less IC card. When the personal computer establishes synchronization within a Piconet between the cellular phone and a PDA and acquires Bluetooth device names of the cellular phone and the PDA, the cellular phone is specified as the communication party on the basis of the device name notified in advance as the card ID. In this technique, the power transfer means are used only for the purpose of specifying the communication party.

### SUMMARY OF THE INVENTION

In general, security is ensured in a wireless transmission system, such as Bluetooth. A unique ID assigned to each device is mutually recognized by the other device, and the sending side embeds the destination ID into a data packet and transmits it with encryption using a security code, such as an ID. The receiving side selects information with its own ID, or with decryption any information not intended for a device is not received.

However, unlike personal computers, portability is considered important for many portable terminals, such as digital cameras, so that an input device, such as a numeric keypad for ID entry, or a large display screen for clearly displaying the entered ID are often not included and without them the operation may become difficult, resulting in a larger probability of error in entering the destination. In particular, it is necessary to ensure security due to privacy concerns when wirelessly transmitting data closely related to personal information, such as photographed data obtained from digital cameras, and it is necessary to correctly specify the destination since transmissions to an unintended destination may give rise to consequential problems.

The present invention is intended to ensure security even when wirelessly transmitting data from a portable terminal, such as a digital camera, and to offer a system that can prevent transmission to unintended destinations. This system can also be configured so as to supply power to the portable terminal. Namely, a simple system can be implemented where the user simply places the digital camera on a docking apparatus so that ID authentication for security can be unmistakably and reliably performed and a secondary battery can be charged by leaving the digital camera on the docking apparatus.

The present invention is a communication system having a portable terminal apparatus and a base station apparatus and performing data communications between the portable terminal apparatus and the base station apparatus. The base station apparatus has power transmitting means for wirelessly transmitting power to the portable terminal apparatus and base station side communicating means for transferring data with the portable terminal apparatus. The portable terminal apparatus has power receiving means for receiving power transmitted wirelessly from the base station apparatus, terminal side communicating means for transferring data with the base station apparatus, and data storing means for storing data to be transmitted to the base station apparatus. The terminal side communicating means transmit a power transmit request command to the base station side communicating means, the power transmitting means wirelessly transmit power when the base station side communicating means receive the power transmit request command from the terminal side communicating means, and the terminal side communicating means transmit data stored in the data storing means to the base station apparatus when power that is wirelessly transmitted from the base station apparatus is received by the power receiving means.

Furthermore, the present invention is a communication system for transmitting photographed data stored in a digital camera to a printer dock or a docking apparatus having a storage function for image data (printer dock and storage docking apparatus are referred to generically as docking apparatus). The docking apparatus has power transmitting means for wirelessly transmitting power to the digital camera, dock side communicating means for transferring data with the digital camera, ID storing means for storing an ID thereof, and means for printing or storing photographed data transmitted from the digital camera. The digital camera has power receiving means for receiving power wirelessly transmitted from the docking apparatus, camera side communicating means for transferring data with the docking apparatus, photographed data storing means for storing photographed data to be transmitted to the docking apparatus, and ID acquiring means for detecting the docking apparatus located within data communication range and acquiring an ID thereof. The camera side communicating means sequentially transmit the power transmit request command to the docking apparatus using the ID acquired by the ID acquiring means, the power transmitting means wirelessly transmit power when the power transmit request command is received from the camera side communicating means by the dock side communicating means, and the camera side communicating means set a data communication party using the ID of the docking apparatus, which is the power transmission source, and transmit photographed data stored in the photographed data storing means to the docking apparatus when power that is wirelessly transmitted from the docking apparatus is received by the power receiving means.

Furthermore, the present invention is a digital camera for performing data communications with a docking apparatus. The digital camera has power receiving means for receiving power that is wirelessly transmitted, ID acquiring means for detecting the docking apparatus located within data communication range and acquiring an ID thereof, and data communicating means for sequentially transmitting a power transmit request command to the docking apparatus using the ID acquired by the ID acquiring means, and when power that is transmitted in response to the power transmit request command is received by the power receiving means, for specifying a docking apparatus for data communications using the ID of the docking apparatus that transmitted the power, and for transmitting photographed data to the specified docking apparatus.

Furthermore, the present invention is a docking apparatus for supplying power to a digital camera and for inputting, then printing or storing, photographed data from within the digital camera. The docking apparatus has ID storing means for storing an ID thereof, means for transmitting the ID in accordance with a request from the digital camera, power transmitting means for wirelessly transmitting power to the digital camera in accordance with a power transmit request specified with the ID, means for receiving the photographed data specified with the ID and transmitted from the digital camera that received the power, and means for printing or storing the photographed data.

In the present invention, when specifying the data communication party, the reception of the power that is wirelessly transmitted from the base station apparatus or the printer dock is a trigger for specifying the communication party. Prior to data communication, the power transmit request is transmitted from the portable terminal or digital camera to the base station apparatus or printer dock, and in response to this request, power is transmitted. When this transmitted power is received, the base station apparatus or printer dock that transmitted the power is specified as the communication party.

According to the present invention, since the communication party is specified by receiving power that is wirelessly transmitted, the communication party can be specified in a simple and reliable manner. Therefore, when transmitting the photographed data and printing to the printer dock, the photographed data can be transmitted only to the specified printer dock that can transfer power.

### BRIEF DESCRIPTION OF THE DRAWINGS

A preferred embodiment of the present invention will be described in detail based on the following figures, wherein:

FIG. 1 is a system conceptual diagram of an embodiment.

FIG. 2 is a block diagram of the embodiment.

FIG. 3 is a processing flowchart for the embodiment.

FIG. 4 is another processing flowchart (standby state) for the embodiment.

FIG. 5 is an authentication processing flowchart in a normal operating state of the embodiment.

### DETAILED DESCRIPTION OF THE INVENTION

A digital camera and a printer dock are illustrated hereinafter for an embodiment of the present invention with reference to the attached figures.

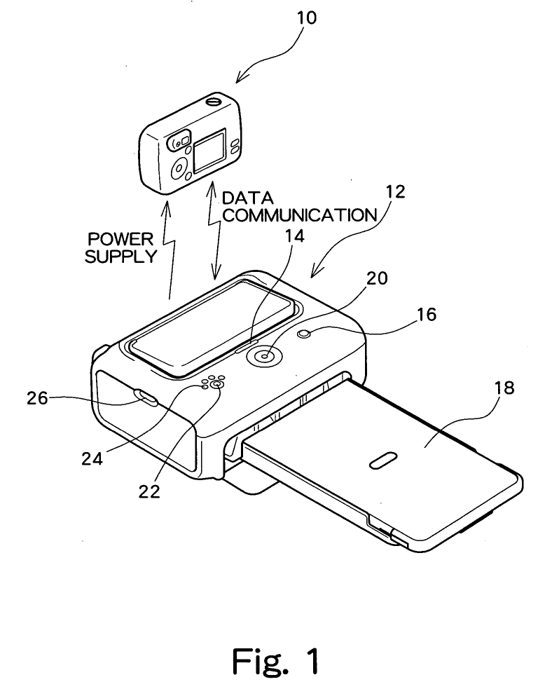

FIG. 1 shows a conceptual diagram of a communication system for the embodiment. The communication system comprises a digital camera 10 and a printer dock 12.

The digital camera 10 has an internal secondary battery, such as a Li-ion battery or Ni-MH battery. Data for photographed images is stored in an internal flash memory. When printing image data, a user positions the digital camera 10 in proximity to the printer dock 12.

The printer dock 12 has a print function for receiving and printing the image data stored in the memory of the digital camera 10 and a function for supplying power to the digital camera 10. When the digital camera 10 is set in proximity to the printer dock 12, the power for the digital camera 10 is supplied wirelessly from the printer dock 12 and not from the internal secondary battery. When a print button 20 is pressed while in a state where communications between the digital camera 10 and the printer dock 12 have been established, a printing process is executed on the basis of the image data stored in the memory of the digital camera 10 and a sheet of paper, which has been loaded beforehand in a paper tray 18, is printed and output. Until printing is completed and the paper is ejected in the printing process, layers of yellow, magenta, and cyan are printed in sequence, and finally a protective layer is coated while the paper moves back and forth several times (such as four times), after which the paper is ejected. Selection of the image to be printed is performed by pressing a selection button located in proximity to the print button 20. By pressing the selection button, the photographed images are sequentially displayed on a rear LCD screen on the digital camera 10 and the user confirms on the LCD screen the image to be printed. The printed image size is switched by pressing an image size button 22 and the current image size is indicated on an image size indicator 24. During charging, the state of charge is indicated on a charging indicator 14. The state of charge is detected by a processor of the digital camera 10 and is wirelessly transmitted to the printer dock 12. The charging indicator 14 comprises three LEDs arranged in a line and the number of lit LEDs is controlled in accordance with the state of charge. Namely, one LED is lit at the start of charging, and two and then three LEDs are lit as the charging progresses. Charging completes as three LEDs are lit. A USB connector 26 is provided on the printer dock 12 for connection to a computer. When the printer dock 12 is connected to a computer and a transfer button 16 is pressed, the image data is transferred form the printer dock 12 to the computer. In this case, the printer dock 12 functions as a USB hub connecting the digital camera 10 and the computer. Furthermore, due to the USB connection, the printer dock 12 functions as a printer that can be controlled from the computer. Moreover, the printer dock 12 also has a USB connector for connecting to a PictBridge compatible digital camera.

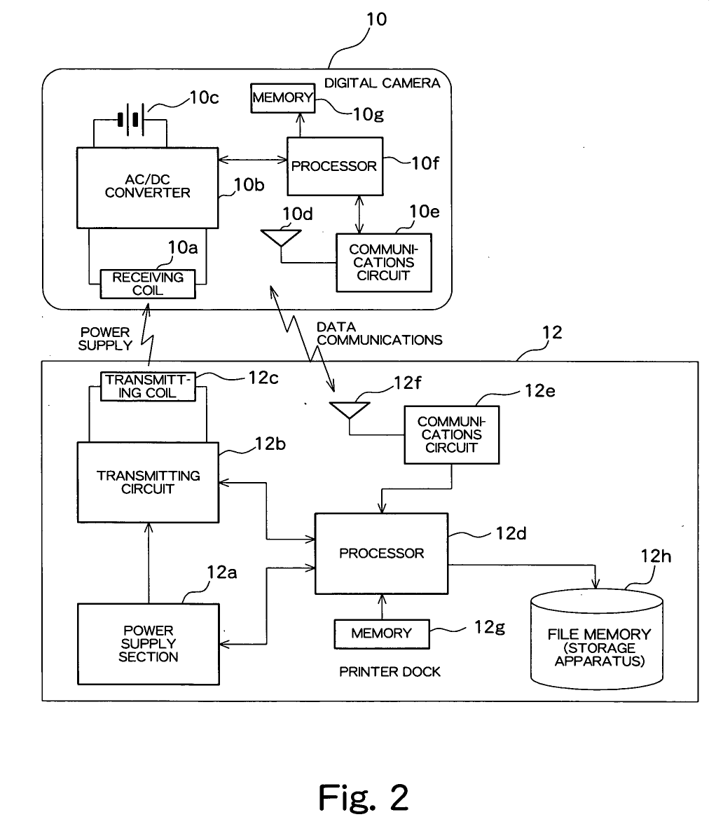

FIG. 2 shows a block diagram of the digital camera 10 and the printer dock 12 in FIG. 1.

The digital camera 10 has two circuit systems: power receiver system and data transfer system. It should be noted that the components for image capture, for example, optical lens, shutter, aperture, image sensor, such as CCD or CMOS, image processor for performing image processing, such as white balance processing or edge processing, memory, such as flash memory for storing photographed data, viewfinder, LCD, various operating buttons, and so forth, are the same as in a conventional digital camera and will be omitted herein. The power receiver system has a receiving coil 10a, an AC/DC converter 10b, and a secondary battery 10c. The data transfer system has an antenna 10d and a communications circuit 10e. The receiving coil 10a receives power that is wirelessly transmitted from the printer dock 12. The AC/DC converter 10b of the power receiver system and the communications circuit 10e of the data transfer system are controlled by control signals from a microprocessor 10f. The power (alternating current power) received by the receiving coil 10a is supplied to the AC/DC converter 10b. The AC/DC converter 10b converts the alternating current power to direct current power, which is then supplied to the secondary battery 10c to charge the secondary battery 10c. Furthermore, the AC/DC converter 10b supplies operating power to various parts of the digital camera 10.

The communications circuit 10c, which is for data communications with the communications circuit at the printer dock 12, detects the printer dock 12 within the communication range and acquires its ID, then uses the ID to transmit a power transmit request command to the printer dock 12. Furthermore, when power is transmitted from the printer dock 12 and received by the power receiver system, the communication party is specified with this power reception as a trigger, the ID of the communication party is registered in a memory 10g, and the photographed data stored in the memory of the digital camera 10 is transmitted to the printer dock 12 using the registered ID. The communication method by the communications circuit 10e is arbitrary and may use 2.4 GHz electromagnetic waves or infrared.

The printer dock 12 has two circuit systems: power transmitter system and data transfer system. It should be noted that the printing system for printing on paper using the photographed data is the same as in a conventional printer and will be omitted herein. The power transmitter system has a power supply section 12a, a transmitting circuit 12b, and a transmitting coil 12c. The power supply section 12a includes a DC/DC converter for converting an external direct current supply to a direct current supply and supplying the direct current power to the transmitting circuit 12b. The transmitting circuit 12b drives the transmitting coil 12c in accordance with a control command (at a timing where a power transmit request is received from the digital camera 10) from a processor 12d, and wirelessly transmits the power. The data transfer system has a communications circuit 12e and an antenna 12f. When the communications circuit 12e receives the power transmit request command that is transmitted from the communications circuit 10e of the digital camera 10, a command received signal is transmitted to the processor 12d. The processor 12d commands the transmitting circuit 12b in response to the command received signal to initiate power transmission. Furthermore, when the photographed data, for which the self ID is specified, is transmitted from the communications circuit 10e of the digital camera 10 to which power was transmitted, it is received by the communications circuit 12e and supplied to a printing circuit. The self ID is stored in a memory 12g, read from the memory 12g by the processor 12d, and transmitted to the digital camera 10 via the communications circuit 12e and the antenna 12f. A file memory (storage apparatus) 12h stores the photographed data that was transmitted from the digital camera and received by the communications circuit 12e. When the printer dock 12 is connected to a personal computer, such as through USB, the image data can naturally be read from and written to the file memory 12h between the printer dock 12 and the personal computer.

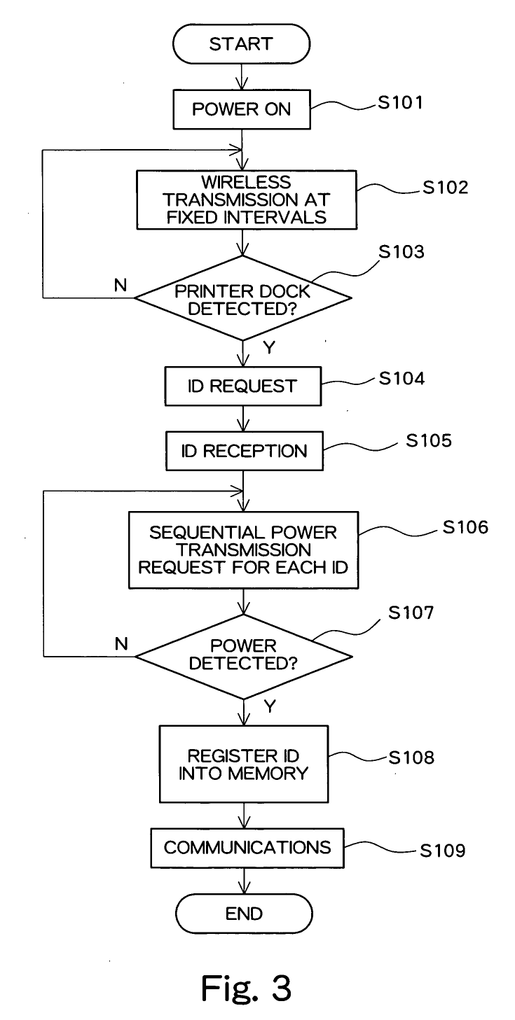

Data communications between the digital camera 10 and the printer dock 12 are described in further detail hereinafter. FIG. 3 shows a processing flowchart at the digital camera 10. First, when the user turns on the power (S101) to the digital camera 10, the processor 10f wirelessly transmits a signal at fixed intervals to detect (S102) the printer dock 12 located within a communication range. Namely, the printer dock 12 located within the communication range is detected by controlling the communications circuit 10e and by broadcasting an IQ (Inquiry) packet at a fixed interval from the antenna 10d and by receiving a response packet for the IQ packet from the printer dock 12. If the printer dock 12 cannot be detected, the wireless transmission (NO at S103) is continued at a fixed interval. If the printer dock 12 is detected (YES at S103), the communications circuit 10e transmits an ID request (S104) for the printer dock 12 that transmitted the response packet. The antenna 12f and the communications circuit 12e of the printer dock 12 receive this ID request and supply it to the processor 12d. In response to this request, the processor 12d reads the self ID from the memory 12g and transmits it to the digital camera 10 via the communications circuit 12e and the antenna 12f. The communications circuit 10e of the digital camera 10 receives the ID that is transmitted from the printer dock 12 and supplies it to the processor 10f. The processor 10f stores the ID into the memory 10g. If multiple printer docks 12 are located within the communication range, multiple IDs are stored in the memory 10g. Here it is assumed that there are two printer docks 12A, 12B having IDs of IDa and IDb, respectively.

The printer docks 12 within the communication range are detected and the IDs of the printer dock 12 are acquired, after which a sequential power transmit request (power transmit request command) is transmitted (S106) to each printer dock 12. More specifically, if IDa and IDb exist, the power transmit request is first transmitted including IDa, and during a fixed period it is confirmed that the power receiver system receives power (S107). If power is not received by the power receiver system even after the elapse of the fixed period (NO at S107), a power transmit stop command is transmitted for that ID. Then, a power transmit request is transmitted including IDb, and during the same fixed period it is confirmed that the power receiver system receives power. When the power transmit request is transmitted including IDa and the communications circuit 12e of the printer dock 12 receives this power transmit request, the processor 12d checks the self ID with the ID within the power transmit request. As a result of the check, if it is judged that there is a match with the self ID, the communications circuit 12b is driven to wirelessly transmit power. The receiving coil 10a of the digital camera 10 receives the wireless power from the transmitting coil 12c and the AC/DC converter 10b converts it to direct current power and supplies it to the secondary battery 10c. When the processor 10f confirms that the power was received at the power receiver system (YES at S107), the ID (IDa in this instance) is re-registered into the memory 10g and an ID for which power reception could not be confirmed is deleted from the memory 10g (S108).

As described hereinabove, the ID of the printer dock 12 that transmitted power is stored in the memory 10g, the processor 10f reads the photographed data from memory and wirelessly transmits it (S109) including the ID that is stored in the memory 10g as the communication party (IDa in this instance). The processor 12d of the printer dock 12 checks the self ID with the ID attached to the photographed data that was wirelessly transmitted from the digital camera 10, and after confirming that the photographed data is for itself, the photographed data is supplied to the printing system and printing is performed. Furthermore, the processor 10f detects the state of charge (SOC) and transmits it to the printer dock 12 via the communications circuit 10e and the antenna 10d.

In this manner, in this embodiment, the power transmit request is output for the printer dock 12 located within the communication range, and the printer dock that wireless transmitted the power in response to this power transmit request is specified as the communication party and the photographed data is wirelessly transmitted. However, if there is one printer dock 12 within the communication range, the power supply is received from that printer dock 12 to charge the secondary battery and the photographed data can be transmitted and printed. Even if there are multiple printer docks 12 within the communication range, the photographed data can be transmitted and printed only for the printer dock 12 that wirelessly transmitted the power. Since only the ID of the printer dock 12 capable of transferring power is automatically set among the printer docks 12 within communication range, this obviates the need for a numeric keypad or the like for specifying the communication party. Since the power reception in this embodiment is a trigger for specifying the communication party, after the power is received and the ID of the printer dock 12 is registered into the memory 10g, data communications continue even if the digital camera 10 and the printer dock 12 exceed the power transfer range. If the power of the digital camera 10 is turned off or if the printer dock 12 does not exist within the data communication range, the processes from S101 are again repeated and a new ID is registered into the memory 10g.

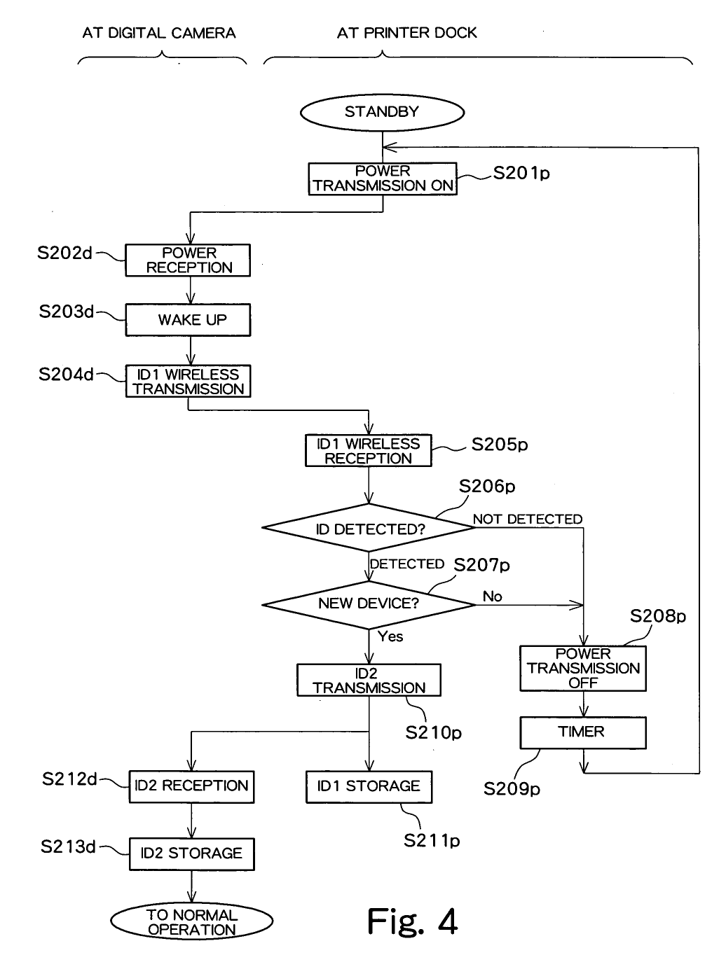

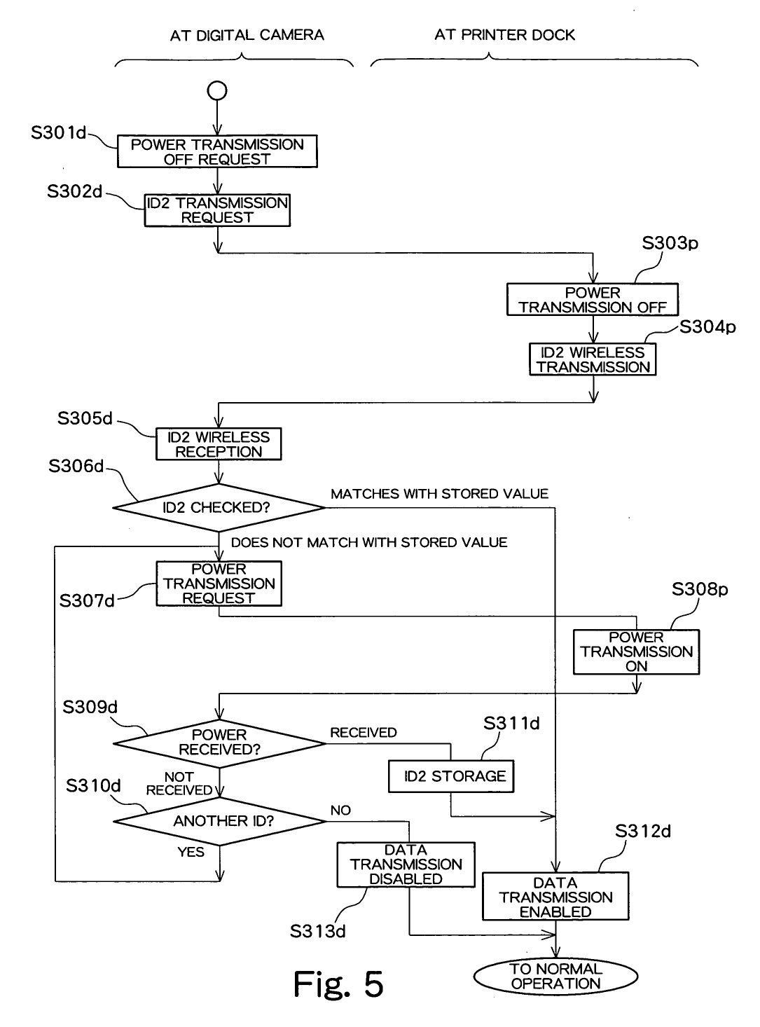

FIGS. 4 and 5 show other processing flowcharts. FIG. 4 is a processing flowchart for the standby state and FIG. 5 is an authentication processing flowchart at an arbitrary timing in a normal operating state subsequent to the standby state. In both figures, for the convenience of description, the processes at the digital camera 10 and the processes at the printer dock 12 are shown separated to the left and right and each processing step is suffixed with a distinguishing letter. A suffix of “p”, such as S101p, denotes a process at the printer dock 12 and a suffix of “d”, such as S102d, denotes a process at the digital camera 10.

In FIG. 4, the printer dock 12 repeats the power transmission (S201p) at a relatively short fixed interval so that the user will not have to wait unduly for an operation to display after placing the digital camera 10 on the printer dock 12. On the other hand, when the digital camera 10 receives power (S202d), its control circuit is designed to initially wake up (S203d) even though it may be in the standby state. When it wakes up due to power reception, its ID (here the ID of the digital camera 10 is ID1) is first wirelessly transmitted (S204d). This ID comprises category information denoting a portable device (digital camera) and ID information that is assigned so as to be unique for every digital camera 10. It is judged (S205p, S206p) whether or not the printer dock 12 has received the ID1 within a predetermined time from power transmission. If the ID1 is not detected within the predetermined time from power transmission, the power transmission is turned off (S208p), a fixed time is counted by a timer (S209p), and the power transmission is again performed (S201p).

If the ID1 is received within the predetermined time from power transmission, it is judged whether or not the received ID1 is identical with the ID1 that is already stored in memory, namely, whether or not it represents a new communication party (S207p). If it is identical to the ID1 that is already stored in memory, the power transmission is turned off, similar to when the ID1 was not received within the predetermined time, and it transfers to the standby state for again performing power transmission after a fixed time (S208p, S209p, S201p). If the received ID1 is a new ID, the printer dock 12 transmits (S210p) ID2, which is its own ID (here it is ID2 to distinguish the ID of the printer dock 12 from the ID of the digital camera). ID2 also comprises category information denoting a base station (printer dock) and ID information that is assigned so as to be unique for every printer dock 12. Furthermore, the 1D1 of the digital camera 10 is stored into memory (S211p).

When the digital camera 10 receives the ID2 (S212d) that was wirelessly transmitted from the printer dock 12, this ID2 is stored (S213d) into a predetermined area in memory, after which data transfers, such as file transmissions, are performed by embedding the ID2 information into a packet and can be received only by the printer dock 12 indicated by ID2.

In FIG. 5, the digital camera 10 transmits (S301d, S302d) the power transmit off command and the ID2 transmit command for the printer dock 12 at an arbitrary timing in the normal operating state. Although the ID2 transmit command is transmitted after the power transmit off command in the figure, their transmission sequence may be reversed so that the power transmit off command may be transmitted after the ID2 transmit command. The printer dock 12 receives these commands, turns off the power transmission (S303p), and wirelessly transmits its own ID2 (S304p).

When the digital camera 10 transmits the ID2 transmit command and the ID2 information is transmitted from the printer dock 12 within the predetermined time, this is received (S305d) and checked (S306d) with the ID2 (refer to S213dof FIG. 4) that has already been stored in memory. As a result of the check, if it matches the ID2 that is stored in memory, a transmit enable flag is set (S312d) because the printer dock 12 was initially authenticated, and normal operation resumes. If it is different from the ID2 that is stored in memory or if there is no stored value, the power transmit command is transmitted (S307d and S310d) to the printer dock 12 of the received ID2 (or in sequential order for every ID2 if there are multiple printer docks) and the digital camera 10 waits to receive power. At the printer dock 12, when the power transmit command is received, the power transmission is turned on (S308p). At the digital camera 10, if the power is received (S309d) within the predetermined time after the power transmit command is transmitted, this indicates a docking state with the printer dock 12 instructed to transmit power so that subsequently the ID2 is stored as the ID of the data communication party (S311d), the data transmit enable flag is set (S312d), and normal operation is resumed.

On the other hand, if power is not received within the predetermined time, this indicates that the authenticated printer dock 12 is not in proximity so that the data transmit enable flag is reset (S313d) and normal operation is resumed.

In the above-mentioned manner, the ID2 of the printer dock 12 that received power is stored into memory, and the data transmit enable flag is set. In the operation of the digital camera 10, when data transmission is performed, such as by user operation, it is judged whether or not the data transmit enable flag has been set. If the data transmit enable flag has been set, the ID2 stored in memory is embedded and data is transmitted. If the data transmit enable flag has not been set, the fact that the printer dock 12 that was authenticated for the user does not exist (power is not on, authentication has not been performed, or does not exist within communication range) is signaled and data transmission is not performed.

The embodiment of the present invention was described hereinabove. As described hereinabove, when the portable device of the present invention receives power, the control circuit initially wakes up even if in the standby state and performs authentication so that no special operation need be performed even for an energy saving portable device and communication is initiated simply by placing it on the base station. However, the present invention is not limited to this and various modifications thereto are possible.

For example, in this embodiment, the ID of the printer dock 12 within communication range is stored into the memory 10g, after which only the ID of the printer dock 12 that wirelessly transmitted power is saved in the memory 10g while any other ID is deleted. However, a flag may be set for the ID of the printer dock 12 that wirelessly transmitted power to specify the communication party, and any other ID need not be deleted from the memory 10g and may be saved.

Furthermore, in this embodiment, an ID request was transmitted and an ID was acquired after the printer dock 12 located within communication range was detected. However, if an IQ packet is broadcast and attribute data for the printer dock 12 is included in response, the attribute data may be acquired as an ID.

Furthermore, in this embodiment, if power is transmitted from multiple printer docks 12, the printer dock 12 with the highest received power may be specified as the communication party. For example, if the power transmit request is transmitted including IDa and power is transmitted from the printer dock 12A in response with a received power of Pa, and if a power transmit request is next transmitted including IDb and power is transmitted from the printer dock 12B in response with a received power of Pb, the magnitudes of Pa and Pb are compared. If Pa<Pb, IDb may be registered into the memory 10g and the printer dock 12B may be specified as the communication party.

Furthermore, in this embodiment, if the power transmit request is transmitted for a certain ID and the received power is detected, it is judged whether or not the received power is greater than or equal to a predetermined threshold. If it is greater than or equal to the predetermined threshold, the ID may be registered into the memory 10g as the communication party. If it is less than the predetermined threshold, the power transmit request may be transmitted for the next ID and the received power may be detected. The ID for which the received power was detected to be greater than or equal to the predetermined threshold may be specified as the communication party. The threshold may be adapted in accordance with the remaining capacity of the secondary battery 10c of the digital camera 10. If the remaining capacity is low, the threshold is increased since the necessity for charging is high. Thus, charging and data communication can both be satisfied. Although charging and data communication may be performed simultaneously, it is likely preferable to execute them non-simultaneously when considering noise interference during data communication. To execute the charging control and data communication non-simultaneously, the control operations are detailed as follows. Namely, the processor 10f monitors the remaining capacity of the secondary battery 10c and it is judged whether or not there is sufficient capacity for the data communication. If there is sufficient capacity for data communication, the data communication is executed, and after the completion of data communication, the secondary battery 10c is charged by the power from the printer dock 12 (authenticated printer dock 12). On the other hand, if there is insufficient capacity for data communication, the secondary battery 10c is first charged by the power from the authenticated printer dock 12, after which the data communication is executed. The data communication may be initiated after fully charging the secondary battery 10c or the charging may be temporarily interrupted at a point where the capacity is sufficient for the data communication and the data communication is initiated, and after completion of the data communication the charging is resumed. The control operation may be switched in accordance with the remaining charge of the secondary battery 10c or with the predicted time until the fully charged state. If the remaining capacity is low and the predicted time until the fully charged state is greater than or equal to a predetermined time, charging is performed until the capacity is sufficient for the data communication, the charging is interrupted, and the data communication is initiated. If the remaining capacity is relatively high and the predicted time until the fully charged state is less than the predetermined time, charging is performed until the fully charged state, after which the data communication is performed. If the time required until the fully charged state is greater than or equal to the predetermined time, the charging control and the data communication may be executed using time division or in an intermittent manner. If there is insufficient power for the data communication and the data communication is to be performed after charging, this information (that charging is to be initiated due to insufficient power for data communication) may be displayed on the LCD screen of the digital camera 10. If data communication is to be performed after the secondary battery 10c is charged and another printer dock 12 besides the authenticated printer dock 12 exists, the power from the printer dock 12 that is not authenticated (namely, not a communication party) may be utilized for charging. The charging control and communication control will be described next based on the flowchart of FIG. 5. If ID2 matches in S306d or if power is received and ID2 is stored into memory in S309d, the data transmit enable flag is set in S312d. However, when setting the flag, the remaining capacity of the secondary battery 10c is detected and it is judged whether or not it is greater than or equal to the threshold. The threshold may be fixed at a default value or set by the user. The threshold may be varied in accordance with the size of the photographed data to be transmitted or with the image format. If the remaining capacity is greater than or equal to the threshold, it is assumed that there is sufficient capacity for the data communication so the data transmit enable flag is set. If the remaining capacity is less than the threshold, it is assumed that there is insufficient capacity for the data communication so the data transmit enable flag is not set (remains in the reset state) and a charge flag is set. The data transmit enable flag is set when the secondary battery 10c is charged in accordance with the charge flag and the remaining capacity is greater than or equal to the threshold. The charge flag is reset and charging is interrupted during data communication, and after the completion of data communication, it is set to a fully charged state and charging is resumed.

Furthermore, in this embodiment, the algorithm for specifying the communication party in accordance with the remaining capacity of the secondary battery 10c may be modified. For example, if the remaining capacity of the secondary battery 10c is less than or equal to a predetermined value and it is judged that charging is necessary, the printer dock 12 that transmits power as described hereinbefore is specified as the communication party. If the remaining capacity of the secondary battery 10c exceeds the predetermined value and it is judged that charging is unnecessary, any printer dock 12 within communication range is specified as the communication party.

If the printer dock 12A and the printer dock 12B exist within the communication range and the printer dock 12A is specified as the communication party, the charging indicator 14 of the printer dock 12A lights to signal that the digital camera 10 is being charged by the printer dock 12A so that a user can easily and visually confirm which printer dock will print the photographed data.

In this embodiment, although a digital camera was given as an example of a portable terminal, a cellular phone or a portable data terminal is applicable. Furthermore, although a printer dock was given as an example of a base station, a cradle having a charging function and data transfer function is applicable.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A communication system comprising a portable terminal apparatus and a base station apparatus and performing data communications between said portable terminal apparatus and said base station apparatus;
said base station apparatus comprising:
power transmitting means for wirelessly transmitting power to said portable terminal apparatus; and
base station side communicating means for transferring data with said portable terminal apparatus;
said portable terminal apparatus comprising:
power receiving means for receiving power transmitted wirelessly from said base station apparatus;
terminal side communicating means for transferring data with said base station apparatus; and
data storing means for storing data to be transmitted to said base station apparatus;
wherein said terminal side communicating means transmit a power transmit request command to said base station side communicating means;
wherein said power transmitting means wirelessly transmit power when said base station side communicating means receive said power transmit request command from said terminal side communicating means;
wherein said terminal side communicating means transmit data stored in said data storing means to said base station apparatus when power that is wirelessly transmitted from said base station apparatus is received by said power receiving means.

2. A system according to claim 1, wherein:
said portable terminal apparatus further comprises identification data acquiring means for detecting the base station apparatus located within data communication range of said terminal communicating means and acquiring identification data unique to each base station;
said base station apparatus further comprises identification storing means for storing identification data thereof;
said terminal side communicating means sequentially transmit the power transmit request command to said base station side communicating means using identification data acquired by said identification data acquiring means;
said power transmitting means wirelessly transmit power when said power transmit request command including identification data thereof is received from said terminal side communicating means;
said terminal side communicating means set a data communication party using said identification data of the base station apparatus, which is the power transmission source, and transmit data stored in said data storing means to said base station apparatus when power that is wirelessly transmitted from said base station apparatus is received by said power receiving means.

3. A communication system for transmitting photographed data stored in a digital camera to a docking apparatus;
said docking apparatus comprising:
power transmitting means for wirelessly transmitting power to said digital camera;
dock side communicating means for transferring data with said digital camera;
ID storing means for storing an ID thereof; and
means for printing or storing photographed data transmitted from said digital camera;
said digital camera comprising:
power receiving means for receiving power wirelessly transmitted from said docking apparatus;
camera side communicating means for transferring data with said docking apparatus;
photographed data storing means for storing photographed data to be transmitted to said docking apparatus; and
ID acquiring means for detecting the docking apparatus located within data communication range and acquiring an ID thereof;
said camera side communicating means sequentially transmit the power transmit request command to said docking apparatus using the ID acquired by said ID acquiring means;
said power transmitting means wirelessly transmit power when said power transmit request command is received from said camera side communicating means by said dock side communicating means;
said camera side communicating means set a data communication party using said ID of the docking apparatus, which is the power transmission source, and transmit photographed data stored in said photographed data storing means to said docking apparatus when power that is wirelessly transmitted from said docking apparatus is received by said power receiving means.

4. A digital camera for performing data communications with a docking apparatus, said digital camera comprising:
power receiving means for receiving power that is wirelessly transmitted;
ID acquiring means for detecting the docking apparatus located within data communication range and acquiring an ID thereof; and
data communicating means for sequentially transmitting a power transmit request command to said docking apparatus using the ID acquired by said ID acquiring means, and when power that is transmitted in response to said power transmit request command is received by said power receiving means, for specifying a docking apparatus for data communications using said ID of said docking apparatus that transmitted the power, and for transmitting photographed data to the specified docking apparatus.

5. A docking apparatus for supplying power to a digital camera and for inputting, then printing or storing, photographed data from within said digital camera, said docking apparatus comprising:
ID storing means for storing an ID thereof;
means for transmitting said ID in accordance with a request from said digital camera;
power transmitting means for wirelessly transmitting power to said digital camera in accordance with a power transmit request specified with said ID;
means for receiving said photographed data specified with said ID and transmitted from the digital camera that received said power; and
means for printing or storing said photographed data.

6. A system according to claim 3, wherein:
said digital camera further comprises means for detecting remaining capacity of an internal secondary battery;
said camera side communicating means transmit said photographed data when said remaining capacity is greater than or equal to a capacity necessary for transmission of said photographed data, and transmit said photographed data after said internal secondary battery has been charged to a capacity greater than or equal to that necessary for transmission of said photographed data by power from said docking apparatus that was set as said data communication party when said remaining capacity is less than necessary for data communication.

7. A digital camera according to claim 4, further comprising:
means for detecting remaining capacity of an internal secondary battery;
said data communicating means transmit said photographed data when said remaining capacity is greater than or equal to a capacity necessary for transmission of said photographed data, and transmit said photographed data after said internal secondary battery has been charged to a capacity greater than or equal to that necessary for transmission of said photographed data by power from said specified docking apparatus.

8. A communication system according to claim 1, said portable terminal apparatus further comprising:
a secondary battery; and
charging means for charging said secondary battery with power transmitted wirelessly from said base station apparatus and received by said power receiving means.
